(19) United States
(12) Patent Application Publication
(10) Pub. No.: US 2009/0313030 A1
(43) Pub. Date: Dec. 17, 2009

(54) PROCESS AND SYSTEM FOR GEOGRAPHICALLY OPTIMIZING THE NET DISPOSABLE INCOME OF A USER

(76) Inventors: A. Matthew Karmel, West Bloomfield, MI (US); Dan M. Karmel, Beverly Hills, MI (US)

Correspondence Address: QUINN LAW GROUP, PLLC, 39555 ORCHARD HILL PLACE, SUITE # 520, NOVI, MI, 48375, US

(21) Appl. No.: 12/137,178

(22) Filed: Jun. 11, 2008

(51) Int. Cl. G06Q 99/00

(52) U.S. Cl. 705/1

(57) ABSTRACT

A computer-based system and process optimize the net disposable income (NDI) of a user based on location. The user populates a profile with user values, and a report is generated containing an optimal geographic match. The match can include locations which minimize financial liabilities to the user, and/or which maximize the NDI of the user, and/or which utilize a formula based at least partially on preferences provided by the user profile. Taxes are considered which are related to each location and expenses based on lifestyle, preferences, and other needs. The system includes a computing device with a central processing unit (CPU), memory, and permanent storage, a display, a user interface, and a program for implementing the process for optimizing the NDI of the user. The program is executable by the computing device, and can be made available over a network communication via Transmission Control Protocol (TCP) and Internet Protocol (IP).

### TECHNICAL FIELD

This invention relates to a computer-based process and a system for optimizing the net disposable income (NDI) of a user based at least partially on geographic considerations.

### BACKGROUND OF THE INVENTION

Retirement is one of the most significant factors in an individual's or a couple's financial and lifestyle planning. Beginning with the creation of a 401k or an Individual Retirement Account (IRA) in one's early 20's, the goal of maximizing one's assets, and thus of optimizing one's retirement lifestyle, can be an almost lifelong consideration.

While people generally realize that geographic location can have a significant impact on their retirement lifestyle, they are often mistaken as to which locations in particular actually constitute the best places to retire from an optimized or maximized net disposable income (NDI) perspective. This misconception can be the result of an overly narrow focus on the impact of various taxes on their NDI. For example, some may focus too closely on the absence of a state income tax in certain states like Florida and Texas and thereby may attribute too much weight or relative importance to this factor. Further, financial planners or advisors to whom individuals often turn for comprehensive advice may likewise improperly base their advice and recommendations in a similarly narrow tax-based fashion.

A narrow focus on state-income or other specific taxes can also affect the planning of individuals outside of the area of retirement planning, for example when choosing where to live when considering competing job offers in different states or communities. Likewise, businesses and corporations may focus too narrowly on certain taxes when planning or selecting locations for Greenfield or Brownfield projects or operations, headquarters relocations, new branches, and/or any other geographical location consideration.

### SUMMARY OF THE INVENTION

Accordingly, a computer-based or implemented process and system is provided for optimizing the net disposable income or NDI of a user. Using the process and system of the invention, a user can optimize a retirement and/or a business planning process, or any other planning scenario in which the user desires to identify an optimal geographic match. Such a geographic match may be “optimal” in that it maximizes the user's NDI, although the geographic match may be optimal in other ways, such as by minimizing the user's overall tax liabilities, and/or minimizing the user's discretionary spending, and/or minimizing the user's non-discretionary spending and/or optimizing other criteria based on the user's preferences. Further, beyond considering the current situation, the user can identify future optimal geographic matches or locations based on known or anticipated/projected financial liabilities or economic structural changes pertaining to each location, thereby providing the user with another level of scrutiny or refinement regarding future optimal geographic matches.

The process includes populating a user profile using a plurality of user input values, finding an optimal geographic match or matches for the user based on the user profile and at least one location profile, and generating a report. The report contains the optimal geographic match which optimizes the NDI of the user. In one embodiment, the optimal geographic match maximizes the NDI of the user, while in another embodiment the optimal geographic match minimizes the overall financial liabilities and/or discretionary and/or non-discretionary spending of the user, and/or other criteria based on the user's preferences.

The system provided in one embodiment of the invention includes a computing device having a central processing unit (CPU), memory, and permanent storage, as well as a display, an interface, and a process, a program, or an algorithm stored in the memory and in the permanent storage for optimizing the NDI of the user. The computing device executes the process to generate a report listing one or more optimal geographic matches. In one embodiment, the system includes a network communication device running the Transmission Control Protocol (TCP) and the Internet Protocol (IP). Network communication from an application which implements the process is performed via hyper text transfer protocol (HTTP) to a web browser application, thus enabling a web-based execution of the process.

The above features and advantages and other features and other advantages of the present invention are readily apparent from the following detailed description of the best modes for carrying out the invention when taken in connection with the accompanying drawings.

### BRIEF DESCRIPTION OF THE DRAWINGS

FIG. 1 is a block diagram of an exemplary embodiment of a computer-based system and process according to the invention;

FIG. 2 is a block diagram of exemplary sources of data used by the system and process of FIG. 1;

FIG. 3 is a flow chart of a process that generates a report with a complete set of optimized locations or optimal matches, and that fine tunes and customizes the report for a user;

FIG. 4 is a block diagram and flow chart of a sub-process or step usable within the process of FIG. 3 for providing an optimal geographic match; and

FIG. 5 is a block diagram and a flow chart of another sub-process or step usable with the process of FIG. 3, wherein certain subtasks are shared or delegated to an external program or software.

### DESCRIPTION OF THE PREFERRED EMBODIMENT

The following descriptions of the physical embodiments of the present invention are for exemplary purposes only. The invention includes but is not limited to the physical settings, computing and programming methods, optimization methods, search algorithms, modeling, databases, storage media, display media, user interfaces and reporting formats, and interfaces with the types of commercial databases and/or software that are described in the following figures.

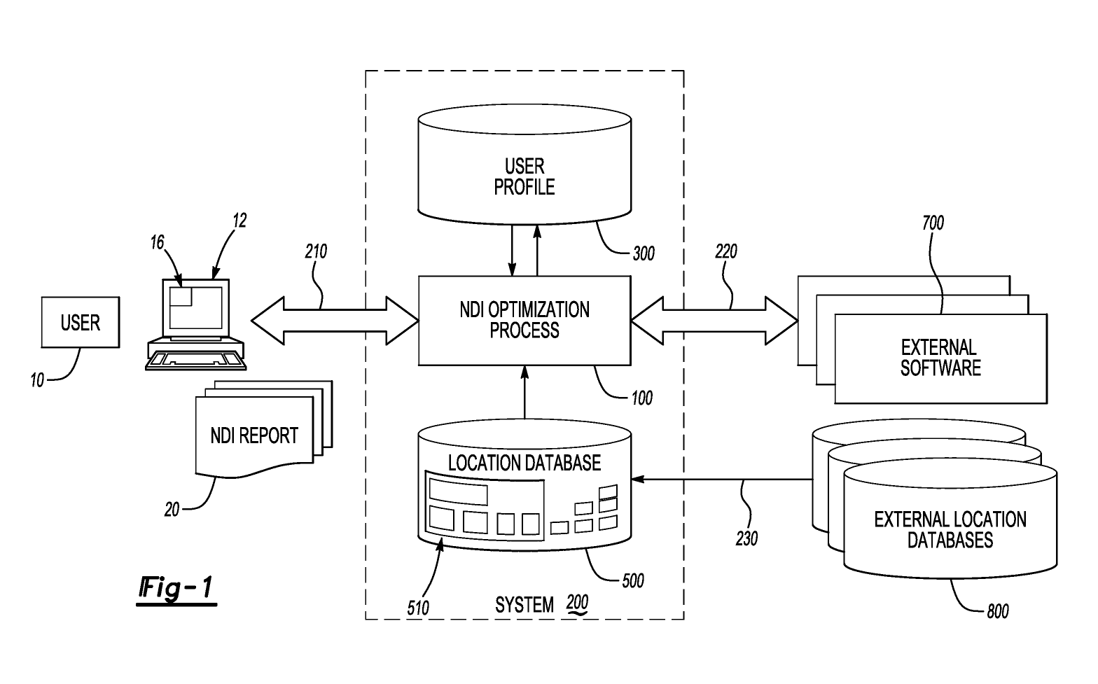

Referring to the drawings wherein like reference numbers represent like components throughout the several figures, and beginning with FIG. 1, a user 10 uses a computing device 12 to interact with a system 200. The user 10 may be any individual or family, a business, and/or a professional such as a consultant or an agent working on behalf of the individual, the family, or the business. The system 200 is a computer-based implementation with a user profile 300, a location database 500, and a net disposable income (NDI) optimization program, method, algorithm, or process 100. The user profile 300, the location database 500, and the algorithm or process 100 may be stored on various data storage devices such as optical, magnetic, and/or semi-conductive media which is readable or otherwise usable by the system 200.

In an exemplary embodiment, data/information can be exchanged between the system 200 and the user 10, between/among the system 200 and one or more commercial programs and software 700, and between/among the system 200 and one or more external location databases 800. Upon completion of the process 100, the system 200 produces, generates, or otherwise prepares an NDI report 20 listing one or more optimal matches or locations to the user 10, as described below.

The user 10 and the system 200 can communicate through a link or connection 210, which can be any interface between a user and a terminal or a personal computer, and which may include a keyboard, a mouse, a display or screen, and/or any other required peripheral devices. As will be understood by those of ordinary skill in the art, the connection 210 is any connection capable of connecting two or more computers, such as but not limited to the internet, local area networks, wide area networks, virtual private networks, and the like. The connection can be broadband, or a phone line or other land line, and can be wired or wireless.

In an exemplary embodiment, the system 200 resides on a remote server, which is accessible over the internet via a web browser as an Application Service Provider (ASP) or Software as a Service (SaaS) offering, but the system 200 could also be implemented in a more traditional stand-alone application for use on a personal computer or on a remote server in a client-server application. The system 200 queries the user 10 through an interactive questionnaire 16 over the connection 210, and then populates the user profile 300 with the user's responses to the questions or with other elements of data from the user 10. Such other elements of data can include financial, investment, or insurance data or information which are automatically imported or downloaded into the user profile 300 from, for example, a commercial financial software package or a web-site of a financial, banking, or wealth-management company.

The user profile 300 can include, but is not limited to, complete and detailed personal data such as the user's age, marital status, dependents; financial data (current as well as projected) such as wages, earnings, investments, real estate holdings, retirement savings, pension benefits, self employment, etc. The user profile 300 can also include the user's geographic preferences, including but not limited to a designated distance from preferred towns, states, or zip codes. The user profile 300 can also include lifestyle data and lifestyle preferences such as living environment, e.g. city, downtown, suburb, country, beachfront, or college town; type of residence, e.g. own or rent, house or condo, etc.; health needs, hobbies, dining preference, vehicle preference, travel profile information such as local, national, or international travel preferences. Data reflecting preferred personal habits such as smoking, club memberships and associations can be included in the user profile 300, as can residency preferences, such as partial, seasonal, or year-round, or how long the user 10 plans to reside in a target location. The user profile 300 can also include proximity preferences to medical, recreational, or other facilities, and/or financial preferences such as desired or expected annual cost-of-living. Other user preferences, dependent and/or independent of location, can also be included in the user profile 300.

The user preferences included in the user profile 300 can be categorized and/or weighted to reflect their relative significance to the user 10 based on the user's input over a spectrum ranging from “no preference” through “light preference” to “absolute preference”, or any similar or other desired rating system.

Still referring to FIG. 1, a location database 500 is defined herein as a collection or set of one or more location profiles 510, with the database 500 also defining a hierarchical order or any other relational arrangement of the various location profiles 510 contained therein. That is, each location profile 510 is configured with a particular level of geographic precision or “granularity”, as represented in FIG. 1 by the different sizes of the various location profiles 510 contained in the location database 500. For example, one level of geographic precision might be a nation or a state as a whole, followed by separate regions, counties, townships, cities, school districts, zip codes, etc. Each location profile 510 can be populated with internal data, such as user-generated data stored in a local database, as well as with external data received from any number of external location databases 800, through a database (DB) uplink connection 230 which can include, but is not limited to, manual data entries, scanning, or electronic interfaces. As with the connection 210 described above, the electronic interfaces can be any connection capable of connecting two or more computers such as the internet, local area networks, wide area networks, virtual private networks, and the like. Likewise, the connection can be broadband or phone line, wired or wireless.

The location profile or profiles 510 contained in the location database 500 consists of data and information related to taxes, non-discretionary and discretionary expenses, life-style expenses, and any other data that may relate to, and/or characterize, a specific location. Tax data include but are not limited to any current tax schedules or rates, known future tax schedules or rates, and/or projected or forecasted tax schedules or rates, for each location. A location profile 510 represents the pertinent data/information for a location within the location database 500. Tax data/information can include, but is not limited to, personal and business state income taxes and taxes levied on: city income, sales, property, licenses, fuel, excise, tobacco, estate or inheritance, restaurants, hotels, car rental, etc. The location profile 510 can also include, but is not limited to, current and projected location-specific rates for out of pocket non-discretionary expenses, e.g., utilities, insurance, medical; current and projected location-specific rates for out-of-pocket discretionary expenses can also be included in the location profile 510 with the expense being dependent on lifestyle, e.g., vacations, hobbies, travel form or standard—air or car or rail and hotel level, etc. Other data/information within the location profile 510 can include but is not limited to, current and projected location-specific data related to potential lifestyle and preferences such as school ratings, religious affiliations, crime rates, weather or climates, air quality, environment, recreation, demographics, including life expectancy, employment, industries, birth and death rates, languages, wages and compensations, occupations, etc.

The system 200 manages the flow of data among the user profile 300, the location database 500, the location profile 510, the external location databases 800, the external software 700, and the user 10, and performs the calculations and the optimizations of the process 100.

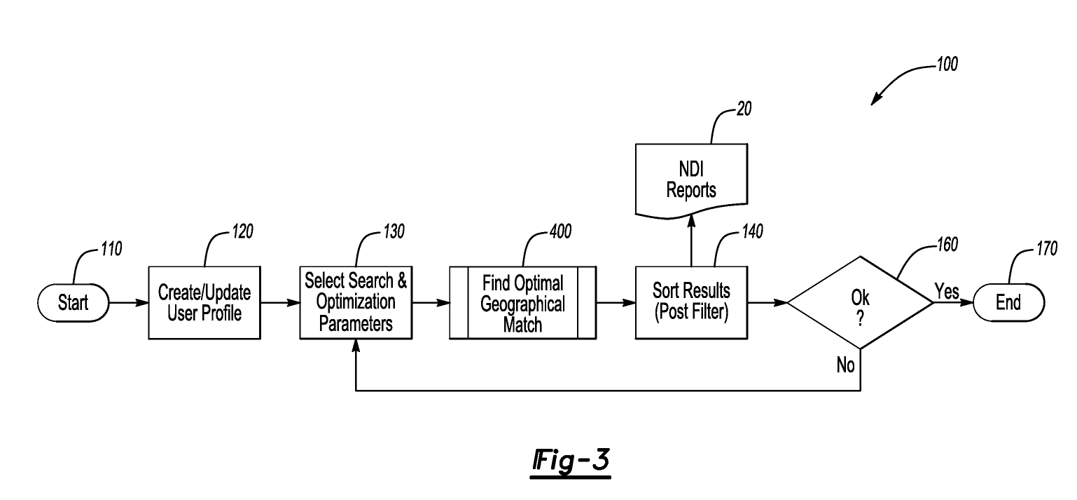

The process 100 identifies one or more optimal geographic matches by searching for locations that meet the optimization criteria selected by the user 10. For example, in one embodiment, the process 100 will minimize total out-of-pocket expenses such as taxes, non-discretionary expenses, and lifestyle-dependent discretionary expenses, thereby maximizing the user's NDI. The process 100 can also project future tax liabilities (see step 130 of FIG. 3) based on federal, state, a provincial, and/or local government financial obligations, for example underfunded pension/health plans, investment losses, and/or economic structural changes such as permanent job losses due to globalization.

The user 10 may choose to restrict or guide the process 100 at step 130 (see FIG. 3) wherein the user 10 may direct the optimization for a specific preferred geographic area, and/or for preferred climates, and/or for preferred types of residence, and/or to proximity to preferred facilities, and/or for the presence (or absence) of preferred associations (e.g., social, commercial, political), and/or any other possible search parameters.

The process 100 generates the NDI report 20 as described above presenting rank-ordered locations that optimize the user's NDI per the selected criteria, and may offer recommendations and/or options for adjusting the user's preferences or lifestyle, with the recommendations and/or options further optimizing the NDI.

In one embodiment, the system 200 connects with external software 700 through a remote procedure call (RPC) connection 220. The connection 220 can be an actual RPC connection, or an import/export function with supporting scripts, or something equivalent, as will be understood by those of ordinary skill in the art. The system 200 may provide the user profile 300 or the location profiles 510, or both, to the external software 700 and then receive results of calculations of the external software 700, which the system 200 then uses for additional processing. Examples of external software 700 include, but are not limited to, commercially available tax programs, search and optimization programs, travel calculators or web-based map generator programs, or other public or proprietary programs which may be able to perform specific subtasks. As with the connection 210 and the DB uplink connection 230 described above, the connection 220 can be any connection capable of connecting two or more computers such as the internet, local area networks, wide area networks, virtual private networks, and the like. Likewise, the connection can be broadband or phone line, wired or wireless.

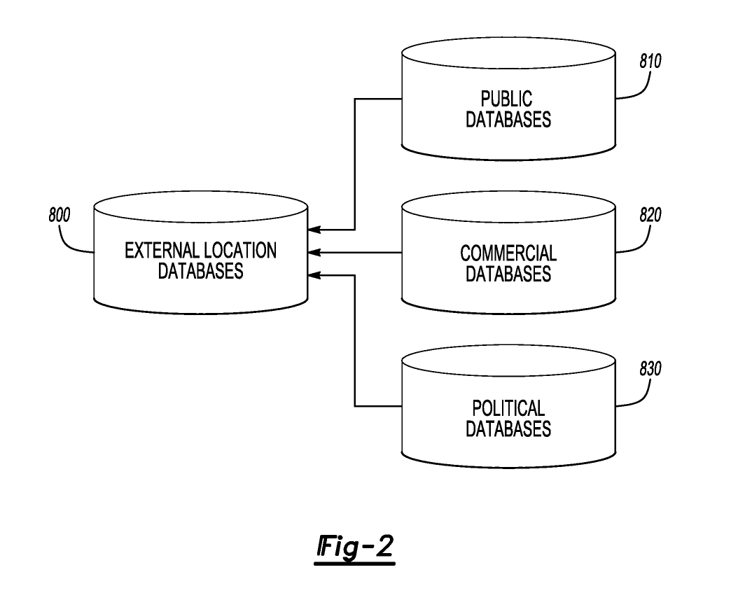

Referring to FIG. 2, sources of data for the external location databases 800 of FIG. 1 may include public databases 810, commercial databases 820, or political databases 830. Public databases 810 can include, but are not limited to, U.S. Department of Commerce Census Bureau, U.S. Department of Commerce Bureau of Economic Analysis, individual state tax and revenue departments, individual county, township, city, school-district tax and revenue departments, State Tax Handbooks such as those published by C.C.H. Inc., Federation of Tax Administrators, The Tax Foundation, or National Conference of State Legislatures. Commercial Databases 820 can include, but are not limited to, databases such as the Multiple Listing Service (MLS) or American Association of Retired Persons (AARP). Political Databases 830 can include, but are not limited to, databases dedicated to collecting and retaining such data as demographics and precinct voting held by governmental or non-governmental groups.

Referring to FIG. 3, the process 100 begins at the start step 110 during which the system 200 of FIG. 1 initializes by clearing any extraneous or residual data left over from incomplete or prematurely terminated prior searches as needed, prior to processing a new request (the term “search” is used herein to describe the process of finding optimal matches based on selected optimization criteria). After the system 200 has initialized, the process 100 proceeds to step 120 wherein the user 10 is queried if a user profile has been created, if the user 10 wants to update it (if one exists), or if the user 10 wants to create a new profile (permanent or temporary). If the user 10 chooses to update an existing profile or to create a new one, the user 10 is prompted to input data or answer questions to thereby collect and/or record a plurality of user inputs which populate the user profile 300. For example, a web-based HTML form may be used, and/or a question or questions presented which, depending upon the answers provided by the user 10, might automatically download or import information from a local or external data source as described previously hereinabove. In an exemplary embodiment, the user 10 will create, modify, or select a profile which will then remain unchanged during the entire optimization process, but other embodiments may offer iterative and interactive options to update the user profile 300 at any point during the optimization process.

Next, the process 100 proceeds to step 130, wherein the user 10 determines the scope of the search and calculations. The user 10 is first queried as to whether to continue a previously saved search or start a new one. The user 10 then selects (or modifies, if the user 10 chooses to continue a previous search) the search parameters, e.g., directs the search to specific geographic locations and/or climates, and/or for a specific preferred type of residence, and/or to proximity to specific preferred facilities, and/or for the presence (or absence) of specific preferred associations (e.g., social, commercial, political), or any other possible combination of search parameters. The search parameters may default to preferences already contained in the user profile 300, or the user 10 may choose to override the default preferences for the purpose of a specific search/optimization. In step 130 the user 10 also selects the optimization criteria, e.g., maximizing the NDI, minimizing discretionary or non-discretionary expenses, optimizing financial and non-financial preferences, or some combinations of the above. Finally, in step 130 the user 10 selects the time frame for the search: present and/or future (one or several scenarios). The selection made in step 130 will guide the calculations/optimization for this search.

The process 100 then proceeds to the optimization process 400 based on the parameters selected in step 130. The optimization process 400 takes into account all the data in the user profile 300 and the location profiles 510 within the location database 500 to identify and present to the user 10 a list of optimal geographic matches rank ordered per the optimization criteria. The process 100 then moves to the post-filter step 140, in which the user 10 can sort the data interactively, filter out some results (e.g., retain only selected top ranks, eliminate specific locations from the ranked list, etc.) and generate intermediate NDI reports 20. For example, the NDI Report 20 could present the ten highest NDI locations in the United States presented in descending order, or per the user's direction e.g., the five highest NDI locations in Michigan, or the Midwest, or in a certain climate range, etc. The user 10 can also choose to return to step 130 to modify the search parameters and run another search. This iterative process may repeat as many times as directed by the user 10. At any point in the process the user can create intermediate or final reports, save a search, etc. In another embodiment, the process 100 will also enable the user to return to step 120 and repeat the session with another (or modified) user profile.

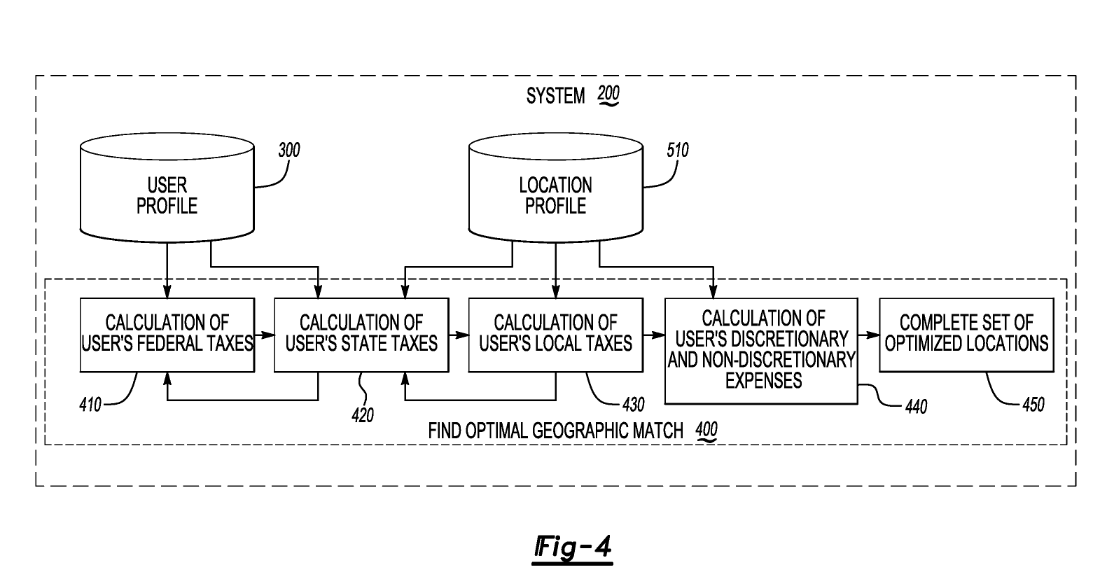

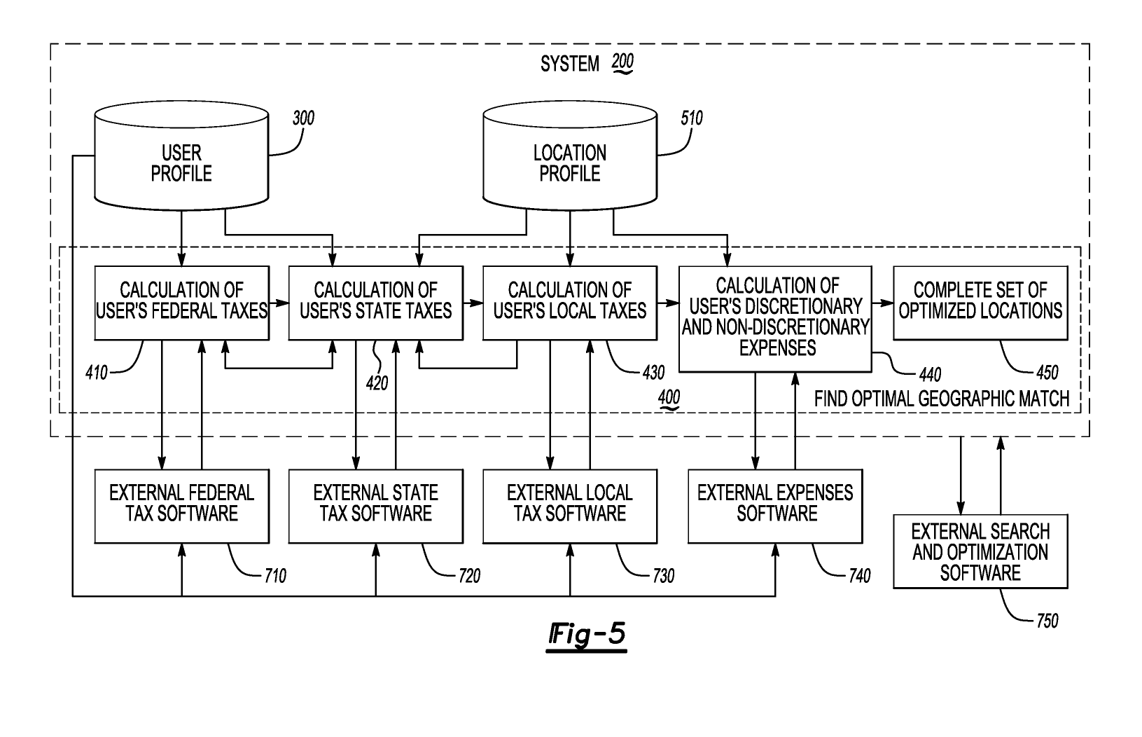

Referring briefly again to FIG. 1, in each session, queries and data may flow in both directions between the process 100 and the user profile 300, the location profiles 510, the location database 500, any external location databases 800, and if necessary, the external software 700. The result of this repeated refinement is to adjust the contents of the complete set of optimized locations 450 (see FIGS. 4 and 5), and it may be done interactively, iteratively, and/or repeatedly for as many times as the user 10 wishes to explore or refine the range of options.

In the end, when the user 10 is finished, the process 100 moves to step 170 and the session ends.

The NDI reports 20 can be sent by the system 200 to the user 10. Such NDI reports 20 can include but are not limited to printed paper reports, verbal reports, reports sent via electronic means, electronic computer documents, and/or reports displayed to the user on a website, a display, a mobile phone, or other peripheral devices.

Referring to FIG. 4, step 400 of FIG. 3 described above is shown in more detail beginning with step 410, wherein the system 200 (see FIG. 1) calculates the user federal taxes based on the data in the user profile 300, and then stores the results in internal data-storage or memory (not shown). The process 100 then proceeds to step 420, and calculates the user's state taxes in every state. For these calculations the process 100 uses the results from step 410, data from the user profile 300, and data from the location profiles 510. Again, the process 100 stores it in internal data-storage or memory (not shown).

The process 100 then proceeds to step 430, and calculates the user's local taxes at every level of desired granularity or geographic precision including, but not limited to: country, state, city, county, township, precinct, school district, zip code, and address. Local taxes calculated in step 430 can include, but are not limited to, taxes for local governments (e.g., city, township, county, etc.), school taxes, property taxes, sales taxes, capital-gains taxes, taxes on prescription drugs, or licenses (e.g., state, county, city). Miscellaneous taxes can include such taxes as intangibles, gift, severance (oil), stock transfer, deed transfer, estate and inheritance taxes, or excise taxes on fuel and/or tobacco based on the user's preferred life style and local tax-rates. For these calculations it uses the results from the previous steps 410 and 420, data from the user profile 300, and data from the location profiles 510. Again, the results are stored in internal data-storage or memory (not shown). Step 400 may repeat step 410 and step 420 in order to recalculate the federal and state taxes that would be paid in each location, now considering the effect of the local results.

State and local taxes calculated in steps 420 and 430 can include the effect of local exemptions when applicable, such as homestead exemptions, social security exemptions, military disability exemptions, etc.

The process 100 then proceeds to step 440 in which the process 100 calculates the user's discretionary and non-discretionary expenses for each of the locations. Non-discretionary expenses can include, but are not limited to, cost of utilities, insurance, food, medication, etc., based on local rates and the user's data such as the desired type of home, number and type of cars, partial, seasonal, or year-round residence preferences, etc. Discretionary expenses can include, but are not limited to, cost of hobbies, club memberships, dining, travel profile, habits. Results are stored in the internal data-storage or memory (not shown) of the system 200. Step 400 then performs a search and optimization process to identify the locations that maximize or that otherwise optimize the user's NDI among all the stored results. These locations are presented to the user as the complete set of optimized locations 450 grouped and ordered per the selected optimization criteria.

Along with the list of locations, rank-ordered according to their NDI scores or other criteria, the user 10 will ultimately be presented with a data/information profile for each location organized per default templates or tailored to the user's preferences or interests, for example, school ratings, crime rate, employment/wage data, demographics, and/or religious affiliations. Along with the locations and their NDI scores, the complete set of optimized locations 450 will suggest potential adjustments to the user's lifestyle and preferences whose degree of importance is not “absolute preference” to further minimize present and future expenses and tax liabilities to the user, thereby further optimizing the user's NDI. These lists and data/information may be communicated to the user 10 via the NDI report 20 (see FIG. 1) in any number of ways, including but not limited to: on a computer screen, sent to a file, printed, mailed, or emailed. If directed to do so by the user 10 in step 130, the system 200 will project future tax liabilities (see FIG. 3) by repeating steps 410, 420, 430, and 440 to calculate future changes in federal, state, and local taxes in each (or in some specific) location based on known or expected federal, state and local government financial obligations, e.g., underfunded pension/health plans, investment losses, known expected changes in tax rates (e.g., of utilities), and economic structural changes such as permanent job losses due to globalization.

Referring to FIG. 5, step 400 is again presented in more detail, but this time certain subtasks are delegated to external software 700 (see FIG. 1). For example, in steps 410, 420, and 430, when the optimal geographic match calculation performed at step 400 calculates the user's federal, state, and local taxes, the system 200 may send data from the user profile 300 and location profiles 510 to external tax calculation programs 710, 720, and 730 to calculate some or all of the user's expected taxes. An agent or consultant working on behalf of a user 10 may use a proprietary tax program not available to the public in the same manner. To calculate the user's discretionary and non-discretionary expenses in step 440, the system 200 may delegate some of the required calculations of subtasks to external expense software 740 (for example, cost-of-living calculators) to speed or “fine tune” the results. Results can be stored in the internal data-storage or memory (not shown) of the system 200. Step 400 and the system 200 may also interface external search and optimization programs or software 750 to help speed or “fine tune” the overall optimization process. The external software 700 may be public programs, proprietary programs, or public programs custom tailored for this invention.

While the best modes for carrying out the invention have been described in detail, those familiar with the art to which this invention relates will recognize various alternative designs and embodiments for practicing the invention within the scope of the appended claims.

1. A computer-based process for optimizing the net disposable income (NDI) of a user based on at least one location profile, the process comprising:
populating a user profile using a plurality of user input values;
finding at least one optimal geographic match for the user based on the user profile and the at least one location profile; and
generating a report containing the at least one optimal geographic match that optimizes the NDI of the user;
wherein optimizing the NDI of the user includes at least one of: maximizing the NDI of the user, minimizing discretionary expenses of the user, minimizing non-discretionary expenses of the user, and utilizing an optimization formula based at least partially on the user profile.

2. The process of claim 1, wherein optimizing the NDI of the user includes minimizing at least one of: tax liabilities of the user, the discretionary expenses of the user, and the non-discretionary expenses of the user.

3. The process of claim 2, wherein the tax liabilities of the user includes at least one of: federal taxes, provincial taxes, state taxes, local taxes, property taxes, school taxes, business taxes, corporate taxes, sales taxes, excise taxes, intangible taxes, capital-gains taxes, estate taxes, inheritance taxes, licenses, severance taxes, and gift taxes.

4. The process of claim 1, wherein the at least one location profile includes a plurality of location profiles each having a different level of geographic precision.

5. The process of claim 4, wherein the at least one location profile receives data from at least one of: a public database, a commercial database, and a political database.

6. The process of claim 1, further comprising:
questioning the user to determine the plurality of user input values by presenting questions interactively to the user concerning the user's preferences.

7. The process of claim 1, wherein the user profile includes at least one of: personal data of the user, financial data of the user, lifestyle preferences of the user, and residence expectations of the user.

8. The process of claim 7, wherein the user profile includes the lifestyle preferences and the residence expectations of the user; and
wherein the lifestyle preferences and the residence expectations are presented on a rating scale.

9. The process of claim 1, wherein finding the at least one optimal geographic match is based on at least one of business environment parameters, local wage structure, labor laws, unionization, supply base, availability of professional workforce, competition, logistics infrastructure, and local-government incentives.

10. The process of claim 1, wherein the process is adapted to allow the user to guide the optimization process based on at least one of: a preferred geographic area, a preferred climate, a preferred type of residence, a preferred proximity to a desired facility, and a preferred association of the user.

11. The process of claim 1, wherein the user defines the optimization criteria based on at least one of: maximizing the NDI of the user, minimizing discretionary expenses, minimizing non-discretionary expenses, optimizing financial preferences, and optimizing non-financial preferences.

12. The process of claim 1, wherein the report generated presents a list of rank-ordered locations that optimize the NDI of the user with recommendations and options for adjusting the user's preferences to further optimize the NDI of the user.

13. The process of claim 1, wherein finding the at least one optimal geographic match includes:
calculating taxes for at least one of: a federal government level, a provincial government level, a state government level, and a local government level;
calculating a current expense liability and a current tax liability for the user for the at least one location profile; and
determining the lowest value of the current expense liability and the current tax liability.

14. The process of claim 13, further comprising:
projecting future tax liabilities for the user based on a known future change to at least one government tax schedule.

15. The process of claim 13, further comprising:
projecting future tax liabilities for the user based on at least one of: a federal government financial obligation, a state government financial obligation, a provincial government financial obligation, a local government financial obligation, a pension plan, an investment, and an economic structural changes.

16. The process of claim 1, further comprising:
using an iterative post-filter to sort and fine-tune the at least one optimal geographic match.

17. The process of claim 16, wherein the iterative post-filter organizes the at least one optimal geographic match based on criteria which are interactively and iteratively chosen by the user.

18. The process of claim 17, wherein the post-filter adds restrictions that are based on at least one preferred geographic feature; and
wherein the at least one preferred geographic feature includes at least one of: a preferred geographic area, a preferred climate, a preferred type of residence, a preferred proximity to a desired facility, and a preferred association of the user.

19. A computer-based process for optimizing net disposable income (NDI) of a user based on at least one location profile, the process comprising:
questioning the user to populate a user profile by presenting questions interactively to the user to determine a preference of the user;
specifying a geographic preference;
calculating a current tax, a future tax, and a projected tax for at least one of a federal, a province, a state, and a local government;
calculating a current living expense, a future living expense, and a projected living expense for at least one of a federal level, a provincial level, a state level, and a local level;
finding a set of optimal geographic matches for the user based on the user profile, the location database, and the geographic preference; and
generating a report with the set of optimal geographic matches;
wherein the report includes the set of optimal geographic matches for the user which optimizes the NDI of the user by maximizing the NDI of the user and minimizing at least one liability value of the user.

20. The process of claim 19, further comprising:
finding the set of optimal geographic matches for the user based on at least one of: taxes, discretionary spending of the user, non-discretionary spending of the user, licenses, real estate prices, job opportunities, comparative cost-of-living, and business opportunities.

21. A computer system adapted for optimizing a net disposable income (NDI) of a user, the computer system comprising:
a computing device configured with a central processing unit (CPU), memory, and permanent storage;
a display device operatively connected to the computing device;
a user interface configured for use with the display device; and
a program for implementing a process for optimizing the NDI, wherein the program is executable by the computing device and is stored in the memory and the permanent storage;
wherein the computer system implements the process to thereby optimize the NDI of the user.

22. The computer system of claim 21, wherein the program includes an application which runs locally on one of the CPU and the memory of the computer device.

23. The computer system of claim 22, further comprising a network communication device, wherein the application is accessible by a remote user over the network communication device utilizing a protocol selected from the group consisting of: Transmission Control Protocol (TCP) and Internet Protocol (IP).

24. The computer system of claim 23, wherein the application enables the process as one of a web-based Application Service Provider (ASP) and a Software as a Service (SaaS) offering.
